(19) United States
(12) Patent Application Publication
(10) Pub. No.: US 2016/0198285 A1
(43) Pub. Date: Jul. 7, 2016

(54) Method And Internet Of Things System For Controlling An Electronic Device

(71) Applicant: Szu-Tung Lin, Tainan City (TW)

(72) Inventor: Szu-Tung Lin, Tainan City (TW)

(21) Appl. No.: 14/985,764

(22) Filed: Dec. 31, 2015

(30) Foreign Application Priority Data
Jan. 5, 2015 (TW) 104100062

(51) Int. Cl. H04W 4/00; H04W 24/08; H04B 17/318; H04L 29/08

(52) U.S. Cl. CPC H04W 4/006; H04L 67/12; H04W 24/08; H04B 17/318; H04W 4/008

(57) ABSTRACT

A method for controlling an electronic device includes steps of: designating one of IoT devices as a master device, and the other IoT devices as slave devices; determining whether the slave device is connectable to the master device; connecting to the master device if affirmative; otherwise, connecting to at least one of the other slave devices which is not yet communicably connected to the slave device, so that at a signal transmission path exists between the master device and each slave device; receiving an operation control signal, and transmitting the same to the master device; and transmitting by the master device the operation control signal to a specific one of the IoT devices for controlling the electronic device.

### CROSS-REFERENCE TO RELATED APPLICATION

This application claims priority of Taiwanese Application No. 104100062, filed on Jan. 5, 2015, the entirety of which is incorporated by reference.

### FIELD

The disclosure relates to a method and a system, more particularly to a method and an Internet of Things (IoT) system for controlling an electronic device.

### BACKGROUND

With the rapid development of computer and network communication technology, relevant applications have been popularized in daily life. For instance, one may use a mobile device, such as a smart phone, to communicate with another, to browse mass information on the Internet, and so forth.

Furthermore, a user may operate the mobile device to control operation of an electronic device via short-range wireless communication technology, such as Bluetooth or Wi-Fi. For example, the mobile device may be operated to control operation of a smart television having Bluetooth or Wi-Fi communication compatibility. However, short-range wireless communication technology, by definition, has a limited transmission range.

### SUMMARY

Therefore, an object of the disclosure is to provide a method and an Internet of Things (IoT) system for controlling an electronic device.

According to a first aspect of the disclosure, the method for controlling an electronic device is to be implemented by an IoT system which includes a plurality of IoT devices. Each of the IoT devices is communicably connectable to at least one of the other IoT devices via short-range wireless communication. The electronic device is connected to and controlled by a specific one of the IoT devices. The method includes the following steps of:

by the IoT devices through short-range wireless communication with each other, designating one of the

IoT devices as a master device, and the IoT devices other than the master device as slave devices;

determining, by each of the slave devices, whether the slave device is communicably connectable to the master device;

for each of the slave devices, when it is determined that the slave device is communicably connectable to the master device, communicably connecting to, by the slave device, the master device;

for each of the slave devices, when it is determined that the slave device is not communicably connectable to the master device, and when there exists at least one of the other slave devices which is not yet communicably connected to the slave device, communicably connecting to, by the slave device, at least one of the other slave devices which is not yet communicably connected to the slave device, so that at least one signal transmission path is established between the master device and the slave device;

by one of the IoT devices, receiving an operation control signal associated with the electronic device, and transmitting the operation control signal to the master device via one of the at least one signal transmission path between the master device and said one of the IoT devices which receives the operation control signal; and

when said specific one of the IoT devices which is connected to the electronic device is one of the slave devices, transmitting, by the master device, the operation control signal to said specific one of the IoT devices via one of the at least one signal transmission path between the master device and said specific one of the IoT devices, the operation control signal enabling said specific one of the IoT devices to control the electronic device according to the operation control signal.

According to a second aspect of the disclosure, the IoT system for controlling an electronic device includes a plurality of IoT devices. Each of the IoT devices is communicably connectable to at least one of the other IoT devices via short-range wireless communication. The electronic device is connected to and controlled by a specific one of the IoT devices.

The IoT devices, through short-range wireless communication with each other, designate one of the IoT devices as a master device, and the IoT devices other than the master device as slave devices. Each of the slave devices determines whether the slave device is communicably connectable to the master device. For each of the slave devices, when it is determined that the slave device is communicably connectable to the master device, the slave device communicably connects to the master device. For each of the slave devices, when it is determined that the slave device is not communicably connectable to the master device, and when there exists at least one of the other slave devices which is not yet communicably connected t o the slave device, the slave device communicably connects to at least one of the other slave devices which is not yet communicably connected to the slave device, so that at least one signal transmission path is established between the master device and the slave device. One of the IoT devices receives an operation control signal associated with the electronic device, and transmits the operation control signal to the master device via one of the at least one signal transmission path between the master device and said one of the IoT devices which receives the operation control signal. When said specific one of the IoT devices which is connected to the electronic device is one of the slave devices, the master device transmits the operation control signal to said specific one of the IoT devices via one of the at least one signal transmission path between the master device and said specific one of the IoT devices, the operation control signal enabling said specific one of the IoT devices to control the electronic device according to the operation control signal.

An effect of the disclosure resides in that, by virtue of deciding the master device and the slave devices among the IoT devices, the operation control signal is able to be transmitted via the master device to the slave device which is directly connected to the electronic device for controlling operation of the electronic device.

### BRIEF DESCRIPTION OF THE DRAWINGS

Other features and advantages of the disclosure will become apparent in the following detailed description of the embodiments with reference to the accompanying drawings, of which:

FIG. 1 is a schematic diagram illustrating one embodiment of an Internet of Things (IoT) system for controlling an electronic device according to the disclosure;

FIGS. 2 to 5 are schematic diagrams illustrating one embodiment of communicable connections between IoT devices of the IoT system according to the disclosure;

FIGS. 6 to 7 are schematic diagrams illustrating another embodiment of communicable connections between IoT devices of the IoT system according to the disclosure;

FIGS. 8 to 9 are schematic diagrams illustrating further another embodiment of communicable connections between IoT devices of the IoT system according to the disclosure; and

FIGS. 10 and 11 are a flow chart illustrating one embodiment of a method for controlling an electronic device according to the disclosure.

FIG. 12 is a schematic diagram of a machine in the form of a computer system within which a set of instructions, when executed, may cause the machine to perform any one or more of the methodologies or operations of the systems disclosed herein.

### DETAILED DESCRIPTION

An embodiment of an Internet of Things (IoT) system for controlling an electronic device according to the disclosure includes a plurality of IoT devices. In one embodiment, the IoT system may be deployed in a smart house. Each of the IoT devices may be electrically and/or communicably connected t o at least one electronic device, such as a television or an air conditioner. The IoT system is configured to receive, from a mobile device or stationary device, an operation control signal associated with operation of each electronic device connected to the IoT system, and is configured to control the electronic device according t o the operation control signal.

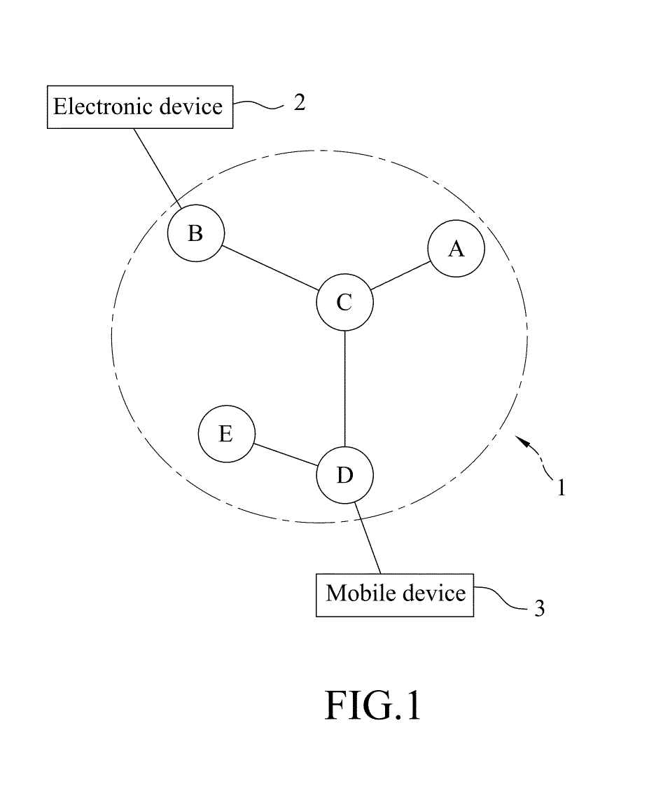

Referring to FIG. 1, in one embodiment, the IoT system 1 is exemplified as including five IoT devices. Each of the IoT devices has a respective serial number, A, B, C, D or E. Each of the IoT devices is communicably connectable to at least one of the other IoT devices via short-range wireless communication, such as Wi-Fi, to form a private cloud. The connection pattern of the IoT devices as shown in FIG. 1 is one of multiple possible connection patterns of the IoT devices. The electronic device 2 is directly connected to and is controlled by the IoT device B. The mobile device 3 is directly connected to the IoT device D via short-range wireless communication or the Internet, and transmits the operation control signal to the IoT device D. Through the private cloud, the operation control signal is transmitted to the IoT device B so as to enable the IoT device B to control the electronic device 2 according to the operation control signal. It should be noted that, even though English alphabets are used to serve as the serial numbers in this embodiment, implementation of the serial numbers is not limited to the disclosure herein. For example, Arabic numerals or even Internet Protocol (IP) addresses may serve to represent the serial numbers, as long as a sequence of the serial numbers is established.

Generation of connection patterns of the IoT devices and transmission scheme of the operation control signal in the IoT system 1 are explained hereinafter. First, after the IoT devices are activated, each of the IoT devices determines, through short-range wireless communication with other IoT devices, whether or not itself has the lowest serial number (i.e., earliest in the sequence) among all of the activated IoT devices. Among themselves, the IoT devices determine which is to serve as a master devices while the others are to serve as slave devices. Herein, the IoT devices designate one of the IoT devices having the lowest serial number as the master device. Therefore, in this embodiment, the IoT device A serves as the master device, and the IoT devices B to E all serve as the slave devices. In another embedment, one of the IoT devices having the highest serial number (i.e., latest in the sequence), i.e., E, may serve as the master device, and the rest of the IoT devices A to D may serve as the slave devices.

In addition, designation of the master device is not limited to the aforementioned approaches. In one embodiment, after the IoT devices are activated, each of the IoT devices, by short-range wireless communication with the other IoT devices, determines whether itself is the first one being activated. Accordingly, the IoT devices can designate one of the IoT devices which was activated first as the master device. In a different embodiment, each of the IoT devices is provided with a switch. Before activation of the IoT device, by setting the switch, each IoT device may be set to be the sole master device or one of the slave devices. After the IoT devices are activated, the IoT devices, through short-range wireless communication with each other, figure out the setup of the master-slave relationship.

Next, each of the slave devices determines whether the slave device is communicably connectable to the master device based on signal strength of short-range wireless communication between the slave device and the master device. That is to say, when the signal strength of short-range wireless communication is greater than a threshold value, the IoT device may be determined as being communicably connectable to the master device. Otherwise, the IoT device is not communicably connectable to the master device. Generally, the signal strength of short-range wireless communication between two devices is negatively proportional to a spatial distance therebetween.

For each of the slave devices, when it is determined that the slave device is communicably connectable to the master device, the slave device communicably connects to the master device. When it is determined that the slave device is not communicably connectable to the master device, and when there exists at least one of the other slave devices which is not yet communicably connected to the slave device, the slave device communicably connects to one of the other slave devices which is not yet communicably connected to the slave device and which has the highest signal strength of short-range wireless communication with the slave device among said at least one of the other slave devices.

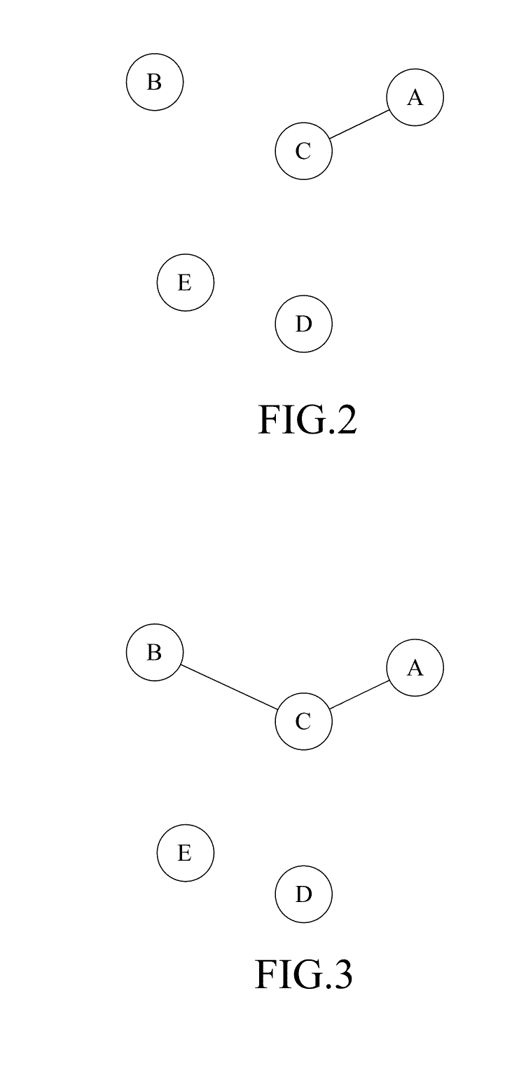

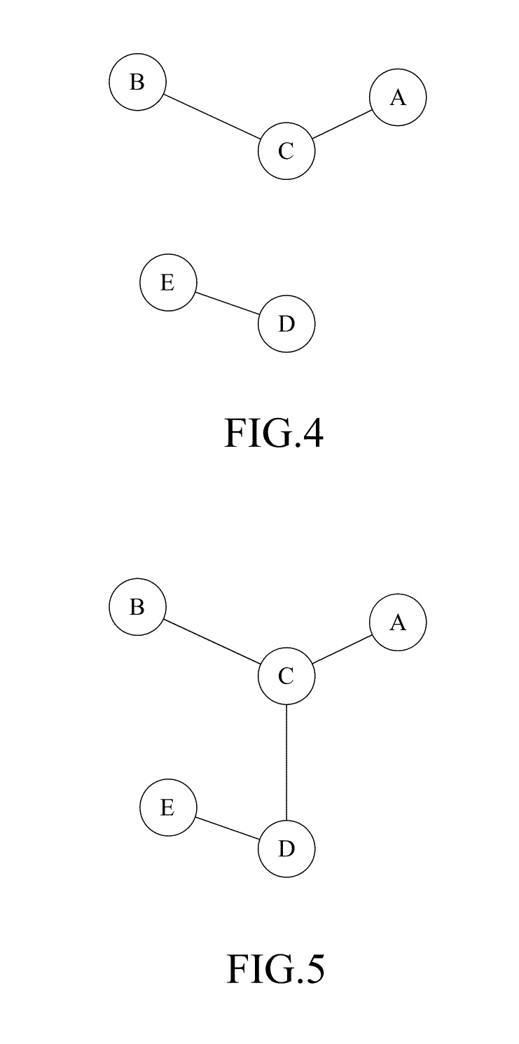

For example, referring to FIG. 2 to FIG. 5, first in FIG. 2, the IoT device C determines that it is communicably connectable to the IoT device A (the master device), and thus establishes communicable connection with the IoT device A. Then, in FIG. 3, upon determining that the signal strength of short-range wireless communication between the IoT device B and the IoT device A is smaller than the threshold value so that the IoT device B is not communicably connectable to the IoT device A, the IoT device B chooses to establish communicable connection with the IoT device C because the IoT device C is not yet communicably connected to the IoT device B and because the short-range wireless communication between the IoT device C and the IoT device B has the highest signal strength in comparison with the short-range wireless communication between the IoT device D and the IoT device B and the short-range wireless communication between the IoT device E and the IoT device B. Next, in FIG. 4, upon determining that the signal strength of short-range wireless communication between the IoT device E and the IoT device A is smaller than the threshold value so that the IoT device E is not communicably connectable to the IoT device A, the IoT device E chooses to establish communicable connection with the IoT device D which is not yet communicably connected to the IoT device E and which has the highest signal strength of short-range wireless communication with the IoT device E among those slave devices not yet connected to the IoT device E (namely IoT devices B, C and D). Finally in FIG. 5, since the signal strength of short-range wireless communication between the IoT device D and the IoT device A is smaller than the threshold value, the IoT device D is not communicably connectable to the IoT device A. Even though the IoT device E has the highest signal strength of short-range wireless communication with the IoT device D, since the IoT device E is already communicably connected to the IoT device D, the IoT device D chooses to establish communicable connection with the IoT device C which has the second highest signal strength of short-range wireless communication therewith (i.e., the highest signal strength of short-range wireless communication among those slave devices not already communicably connected to the IoT device D (namely the IoT devices B and C)).

In another embodiment, for each of the slave devices, when the slave device determines that the slave device is not communicably connectable to the master device, and when there exists at least one of the other slave devices which is not yet communicably connected to the slave device, the slave device further makes a determination as to whether there exists, among said at least one of the other slave devices which is not yet communicably connected to the slave device, at least one slave device which has an existing signal transmission path with the master device. When a result of this determination made by the slave device is positive, the slave device communicably connects to another slave device, among said at least one slave device having an existing signal transmission path with the master device, which has the highest signal strength of short-range wireless communication therewith. When the result of the determination made by the slave device is negative, the slave device communicably connects to one of the other slave devices which is not yet communicably connected to the slave device and which has the highest signal strength of short-range wireless communication therewith.

For example, referring once again to FIG. 2 and FIG. 3, first in FIG. 2, the IoT device C determines that it is communicably connectable to the IoT device A (the master device), and establishes communicable connection with the IoT device A. Then, in FIG. 3, under the circumstance that the signal strength of short-range wireless communication between the IoT device B and the IoT device A is smaller than the threshold value so that the IoT device B is not communicably connectable to the IoT device A, once the IoT device B determines that the IoT device B is communicably connectable to the IoT device C and that a signal transmission path between the IoT device A and the IoT device C has already been established, the IoT device B establishes communicable connection with the IoT device C. Next, with the signal strength of short-range wireless communication between the IoT device D and the IoT device A being smaller than the threshold value so that the IoT device D is not communicably connectable to the IoT device A, once the IoT device D determines that the IoT device D is communicably connectable to the IoT device C, which has an existing signal transmission path with the IoT device A, the IoT device D priorly establishes communicable connection with the IoT device C (this connection is not depicted) even though the IoT device E, among the other IoT devices which have yet been communicably connected to the IoT device D, has the highest signal strength of short-range wireless communication with the IoT device D. Under the same token, the IoT device E communicably connects to the IoT device C (this connection is not depicted).

The aforementioned approach for establishing communicable connections enables a single signal transmission path to exist between the master device and each of the slave devices. However, the approach for establishing communicable connections is not limited to the disclosure herein. In another embodiment, when the slave device determines that it is not communicably connectable to the master device, and when multiple ones of the other slave devices have yet to been communicably connected to the slave device, the slave device may be configured to connect to, based on signal strengths of short-range wireless communication, more than one of the multiple ones of the other slave devices which have relatively higher signal strengths of short-range wireless communication therewith. In this way, there may exist a plurality of signal transmission paths between the master device and each slave device.

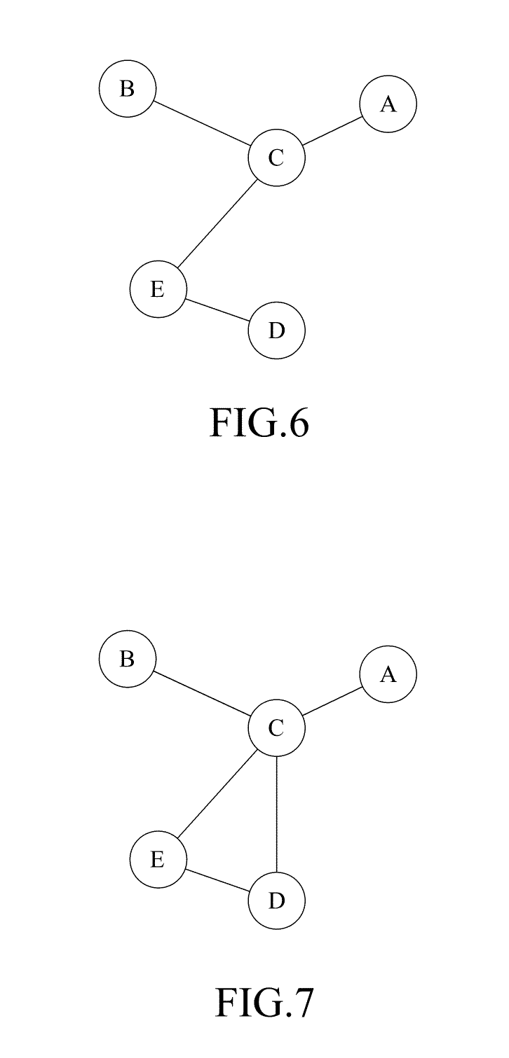

For example, referring to FIG. 6 and FIG. 7, in FIG. 6, after the IoT device C has communicably connected the IoT device A, and after the IoT device B has communicably connected the IoT device C, the IoT device E establishes communicable connections, among the other IoT devices which are not yet communicably connected to the IoT device E (namely the IoT devices B, C, D), with the IoT device D having the highest signal strength therewith and the IoT device C having the second highest signal strength therewith, respectively. Finally, in FIG. 7, the IoT device D establishes communicable connection with the IoT device C. In this way, there exist two signal transmission paths between the IoT device A and the IoT device E.

Furthermore, in one embodiment, for each of the slave devices, when it is determined that the slave device is communicably connectable to the master device, aside from communicably connecting to the master device, the slave device further communicably connects to at least one of the other slave devices which is not yet communicably connected to the slave device and which has relatively high signal strength of short-range wireless communication therewith. As a result, there would be one or more signal transmission paths between the master device and each of the slave devices.

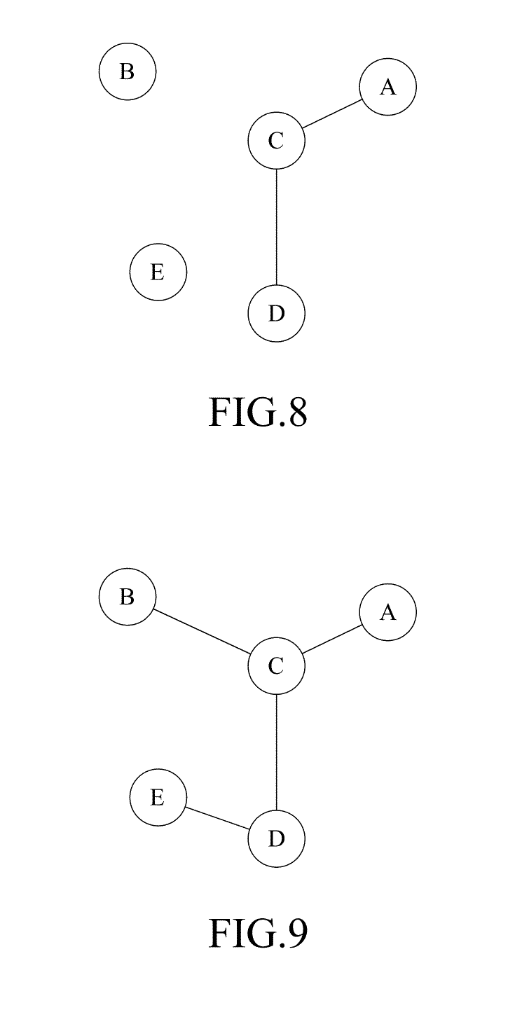

For example, referring to FIG. 8 and FIG. 9, in FIG. 8, the IoT device C first communicably connects to the IoT device A and the IoT device D. Then, in FIG. 9, the IoT device B communicably connects to the IoT device C, and finally, the IoT device E communicably connects to the IoT device D.

Regarding the transmission approach of the operation control signal in the IoT system 1, referring once again to FIG. 1, the mobile device 3 first makes a determination, in a manner of network broadcasting, as to whether the mobile device 3 is communicably connectable to at least one of the IoT devices via short-range wireless communication, and when a result of the determination made by the mobile device 3 is positive, the mobile device 3 communicably connects to the IoT device which has the highest signal strength of short-range wireless communication therewith. When the result of the determination made by the mobile device 3 is negative, the mobile device 3 communicably connects to one of the IoT devices via the Internet.

For example, in this embodiment, the mobile device 3 connects to the IoT device D which serves as the slave deice via short-range wireless communication or the Internet. The mobile device 3 first executes an application program associated with the electronic device 2 so as to generate the operation control signal and to transmit the same to the IoT device D. Then the IoT device D transmits the operation control signal to the IoT device A which serves as the master device. Since the IoT device A has previously recorded relevant information associated with the electronic device, if any, to which each of the slave devices connects, the IoT device A determines that the operation control signal is related to the electronic device 2 connected to and controlled by the IoT device B. Finally, the IoT device A transmits the operation control signal to the IoT device B to enable the IoT device B to control the electronic device 2 according to the operation control signal.

In addition, when there are multiple signal transmission paths between the master device and one of the slave devices, such as between the IoT device A and the IoT device E of FIG. 7, the master device detects transmission quality of each of the signal transmission paths, and selects one of the signal transmission paths having the best transmission quality for transmission of the operation control signal.

It should be noted that, in one embodiment, each of the IoT devices has a service set identifier (SSID) and a password. The mobile device 3 transmits update information associated with the SSID and the password to the master device via one of the slave devices which is connected to the mobile device 3, i.e., the IoT device D. The update information enables the master device to update its SSID and password, and to transmit the update information to each of the slave devices. The update information enables each of the slave devices to update its SSID and password.

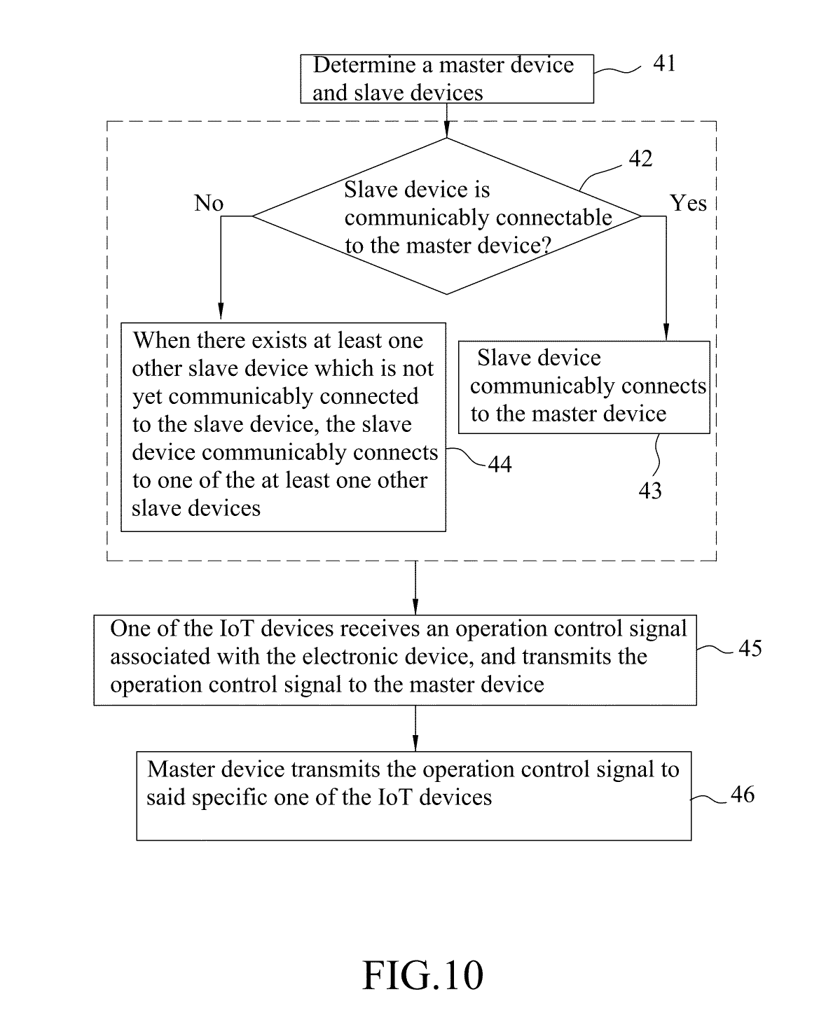

Referring to FIG. 10, an embodiment of a method for controlling an electronic device according to the disclosure is to be implemented by the aforementioned IoT system which includes the plurality of IoT devices. Each of the IoT devices is communicably connectable to at least one of the other IoT devices via short-range wireless communication. The electronic device is connected to and controlled by a specific one of the IoT devices. The method includes the following steps 41 to 46.

First, in step 41, the IoT devices, through short-range wireless communication with each other, determine a master device thereamong, and determine that the IoT devices other than the master device are to serve as slave devices. Specifically, each of the IoT devices has a respective serial number. The IoT devices determine amongst themselves, through short-range wireless communication with each other, that one of the IoT devices having the lowest serial number or one of the IoT devices having the highest serial number is to serve as the master device.

Then, each of the slave devices perform steps 42 to 44.

In step 42, the slave device determines whether the slave device is communicably connectable to the master device based on signal strength of short-range wireless communication between the slave device and the master device. When it is determined by the slave device that the slave device is communicably connectable to the master device, the flow proceeds to step 43; otherwise, step 44 is performed.

In step 43, the slave device communicably connects to the master device.

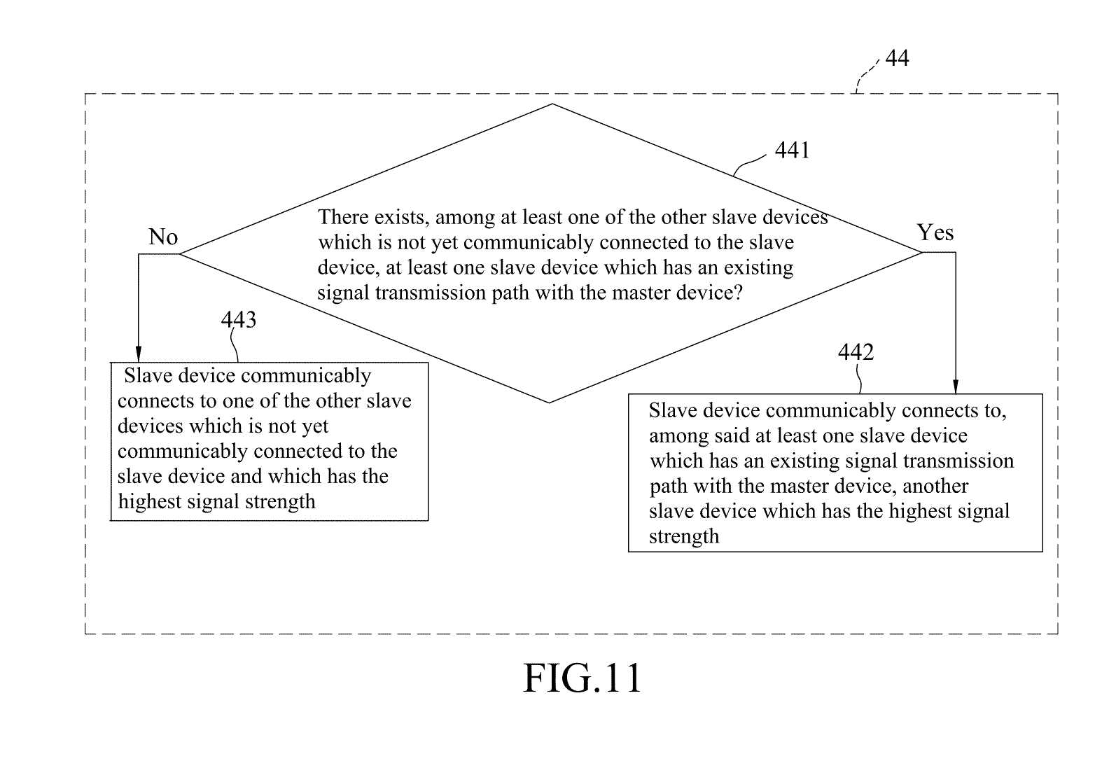

In step 44, when it is determined by the slave device in step 42 that the slave device is not communicably connectable to the master device, and when there exists at least one other slave device which is not yet communicably connected to the slave device, the slave device communicably connects to one of the at least one other slave device, so that at least one signal transmission path is established between the master device and the slave device. Specifically, in one embodiment, the slave device communicably connects to one of the other slave devices which is not yet communicably connected to the slave device and which has the highest signal strength of short-range wireless communication therewith. In another embodiment, referring to FIG. 11, step 44 includes sub-steps 441 to 443. In sub-step 441, when it is determined by the slave device in step 42 that the slave device is not communicably connectable to the master device, and when there exists at least one of the other slave devices which is not yet communicably connected to the slave device, the slave device makes a determination as to whether there exists, among said at least one of the other slave devices which is not yet communicably connected to the slave device, at least one slave device which has an existing signal transmission path with the master device. In sub-step 442, when a result of the determination made by the slave device in sub-step 441 is positive, the slave device communicably connects to, among s aid at least one slave device which has an existing signal transmission path with the master device, another slave device which has the highest signal strength of short-range wireless communication therewith. Otherwise, in sub-step 443, when the result of the determination made by the slave device in sub-step 441 is negative, the slave device communicably connects to one of the other slave devices which is not yet communicably connected to the slave device and which has the highest signal strength of short-range wireless communication therewith.

In step 45, one of the IoT devices receives an operation control signal associated with the electronic device, and transmits the operation control signal to the master device via one of the at least one signal transmission path between the master device and said one of the IoT devices which receives the operation control signal. Said one of the IoT devices which receives the operation control signal is connected to a mobile device via one of the short-range wireless communication and the Internet. The operation control signal is issued by the mobile device. Specifically, in one embodiment, one of the IoT devices which has the highest signal strength of short-range wireless communication with the mobile device receives the operation control signal from the mobile device via the short-range wireless communication therebetween when the mobile device determines that the mobile device is communicably connectable to at least one of the IoT devices via short-range wireless communication and thus communicably connected to the at least one of the IoT devices. Otherwise (i.e., when the mobile device determines that the mobile device is not communicably connectable to any of the IoT devices via short-range wireless communication), said one of the IoT devices receives the operation control signal from the mobile device via the Internet.

Finally, in step 46, when said specific one of the IoT devices which is connected to the electronic device is one of the slave devices, the master device transmits the operation control signal to said specific one of the IoT devices via one of the at least one signal transmission path therebetween. The operation control signal enables said specific one of the IoT devices to control the electronic device according to the operation control signal.

It should be noted here in that the signal transmission path between two elements as recited throughout this disclosure may be a direct signal transmission path between the two elements, or may be an indirect signal transmission path, meaning that the signal transmission path is established via a third element between the two elements.

To sum up, in the method and the IoT system for controlling an electronic device according to the disclosure, the plurality of IoT devices designate one of the IoT devices as the master device, and the IoT devices other than the master device serve as the slave devices. When one of the IoT devices receives from the mobile device the operation control signal associated with the electronic device, and when the operation control signal is relayed to the master device, the master device transmits the operation control signal to said specific one of the IoT devices which is connected to the electronic device for controlling operation of the electronic device according t o the operation control signal. In this way, the electronic device is able to be controlled by the mobile device via the IoT system.

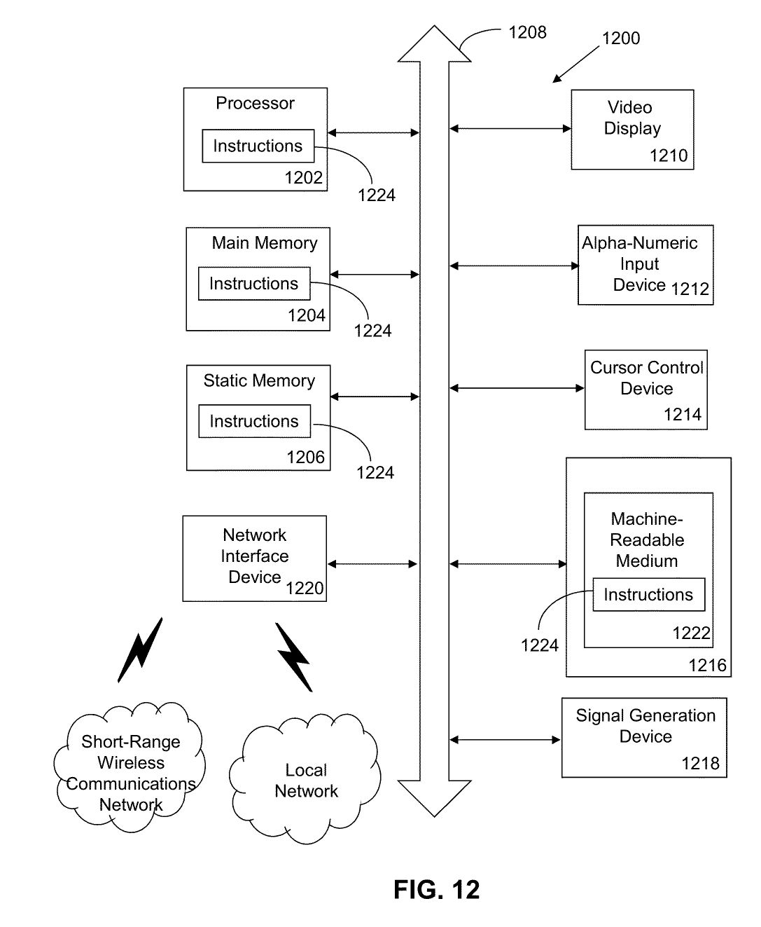

Referring now also to FIG. 12, at least a portion of the methodologies and techniques described with respect to the exemplary embodiments of system 1 can incorporate a machine, such as, but not limited to, computer system 1200, or other computing device within which a set of instructions, when executed, may cause the machine to perform any one or more of the methodologies or functions discussed above. The machine may be configured to facilitate various operations conducted by the system 1. For example, the machine may be configured to, but is not limited to, assist system 1 by providing processing power to assist with processing loads experienced in system 1, by providing storage capacity for storing instructions or data traversing system 1, or by assisting with any other operations conducted by or within system 1.

In some embodiments, the machine may operate as a standalone device, such as a computer system, a server, an electronic device, and/or mobile device. In some embodiments, the machine may be connected (e.g., using a communications network, local network, a short-range wireless communication network, another network, or a combination thereof) to and assist with operations performed by other machines and systems, such as, but not limited to, electronic device 2, mobile device 3, IoT device A, IoT device B, IoT device C, IoT device D, IoT device E, or any combination thereof. The machine may be connected with any component in system 1. In a networked deployment, the machine may operate in the capacity of a server or a client user machine in a server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The computer system 1200 may include a processor 1202 (e.g., a central processing unit (CPU), a graphics processing unit (GPU, or both), a main memory 1204 and a static memory 1206, which communicate with each other via a bus 1208. The computer system 1200 may further include a video display unit 1210, which may be, but is not limited to, a liquid crystal display (LCD), a flat panel, a solid state display, or a cathode ray tube (CRT). The computer system 1200 may include an input device 1212, such as, but not limited to, a keyboard, a cursor control device 1214, such as, but not limited to, a mouse, a disk drive unit 1216, a signal generation device 1218, such as, but not limited to, a speaker or remote control, and a network interface device 1220.

The disk drive unit 1216 may include a machine-readable medium 1222 on which is stored one or more sets of instructions 1224, such as, but not limited to, software embodying any one or more of the methodologies or functions described herein, including those methods illustrated above. The instructions 1224 may also reside, completely or at least partially, within the main memory 1204, the static memory 1206, or within the processor 1202, or a combination thereof, during execution thereof by the computer system 1200. The main memory 1204 and the processor 1202 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the pre sent disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine-readable medium 1222 containing instructions 1224 so that a device connected to a communications network, a local network, a short-range wireless communication network (such as that of FIG. 1), another network, or a combination thereof, can send or receive voice, video or data, and to communicate over the communications network local network, short-range wireless communication network, another network, or combination thereof, using the instructions. The instructions 1224 may further be transmitted or received over the communications network local network, short-range wireless communication network, another network, or combination thereof, via the network interface device 1220.

While the machine-readable medium 1222 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that causes the machine to perform any one or more of the methodologies of the present disclosure.

The terms “machine-readable medium,” “machine-readable device, or “computer-readable device” shall accordingly be taken to include, but not be limited to: memory devices, solid-state memories such as a memory card or other package that houses one or more read-only (non-volatile) memories, random access memories, or other re-writable (volatile) memories; magneto-optical or optical medium such as a disk or tape; or other self-contained information archive or set of archives is considered a distribution medium equivalent to a tangible storage medium. The “machine-readable medium,” “machine-readable device,” or “computer-readable device” maybe non-transitory, and, in certain embodiments, may not include a wave or signal per se. Accordingly, the disclosure is considered to include any one or more of a machine-readable medium or a distribution medium, as listed herein and including art-recognized equivalents and successor media, in which the software implementations herein are stored.

The illustrations of arrangements described herein are intended to provide a general understanding of the structure of various embodiments, and they are not intended to serve as a complete description of all the elements and features of apparatus and systems that might make use of the structures described herein. Other arrangements maybe utilized and derived there from, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description. Therefore, it is intended that the disclosure not be limited to the particular arrangement(s) disclosed as the best mode contemplated for carrying out this invention, but that the invention will include all embodiments and arrangements falling within the scope of the appended claims.

The foregoing is provided for purposes of illustrating, explaining, and describing embodiments of this invention. Modifications and adaptations to these embodiments will be apparent to those skilled in the art and may be made without departing from the scope or spirit of this invention. Upon reviewing the aforementioned embodiments, it would be evident to an artisan with ordinary skill in the art that said embodiments can be modified, reduced, or enhanced without departing from the scope and spirit of the claims described below.

What is claimed is:

1. A method for controlling an electronic device, the method to be implemented by an Internet of Things (IoT) system including a plurality of IoT devices, each of the IoT devices being communicably connectable to at least one of the other IoT devices via short-range wireless communication, the electronic device being connected to and controlled by a specific one of the IoT devices, the method comprising the following steps of:
by the IoT devices through short-range wireless communication with each other, designating one of the IoT devices as a master device, and the IoT devices other than the master device as slave devices;
determining, by each of the slave devices, whether the slave device is communicably connectable to the master device;
for each of the slave devices, when it is determined that the slave device is communicably connectable to the master device, communicably connecting to, by the slave device, the master device;
for each of the slave devices, when it is determined that the slave device is not communicably connectable to the master device, and when there exists at least one of the other slave devices which is not yet communicably connected to the slave device, communicably connecting to, by the slave device, at least one of the other slave devices which is not yet communicably connected to the slave device, so that at least one signal transmission path is established between the master device and the slave device;
by one of the IoT devices, receiving an operation control signal associated with the electronic device, and transmitting the operation control signal to the master device via one of the at least one signal transmission path between the master device and said one of the IoT devices which receives the operation control signal; and
when said specific one of the IoT devices which is connected to the electronic device is one of the slave devices, transmitting, by the master device, the operation control signal to said specific one of the IoT devices via one of the at least one signal transmission path between the master device and said specific one of the IoT devices, the operation control signal enabling said specific one of the IoT devices to control the electronic device according to the operation control signal.

2. The method as claimed in claim 1, wherein the step of determining whether the slave device is communicably connectable to the master device includes:
determining, by each of the slave devices, whether the slave device is communicably connectable to the master device based on signal strength of short-range wireless communication between the slave device and the master device.

3. The method as claimed in claim 1, wherein the step of communicably connecting to at least one of the other slave devices includes:
communicably connecting to, by the slave device, one of the other slave devices which is not yet communicably connected to the slave device and which has the highest signal strength of short-range wireless communication therewith.

4. The method as claimed in claim 1, wherein the step of receiving an operation control associated with the electronic device includes:
receiving, by one of the IoT devices which has the highest signal strength of short-range wireless communication with a mobile device, the operation control signal from the mobile device vi a the short-range wireless communication therebetween when the mobile device determines that the mobile device is communicably connectable to at least one of the IoT devices via short-range wireless communication.

5. The method as claimed in claim 4, wherein the step of receiving an operation control signal associated with the electronic device further includes:
receiving, by one of the IoT devices, the operation control signal from the mobile device via the Internet when the mobile device determines that the mobile device is not communicably connectable to any of the IoT devices via short-range wireless communication.

6. The method as claimed in claim 1, each of the IoT devices having a respective serial number, wherein the step of designating one of the IoT devices as a master device includes:
determining, by the IoT devices through short-range wireless communication with each other, that one of the IoT devices having the lowest serial number or one of the IoT devices having the highest serial number is to serve as the master device.

7. The method as claimed in claim 1, wherein the step of communicably connecting to at least one of the other slave devices includes:
for each of the slave devices, when it is determined that the slave device is not communicably connectable to the master device, and when there exists at least one of the other slave devices which is not yet communicably connected to the slave device, making, by the slave device, a determination as to whether there exists, among said at least one of the other slave devices which is not yet communicably connected to the slave device, at least one slave device which has an existing signal transmission path with the master device;
when a result of the determination made by the slave device is positive, by the slave device, communicably connecting to, among said at least one slave device which has an existing signal transmission path with the master device, another slave device which has the highest signal strength of short-range wireless communication with the slave device; and
when the result of the determination made by the slave device is negative, communicably connecting to, by the slave device, one of the other slave devices which is not yet communicably connected to the slave device and which has the highest signal strength of short-range wireless communication with the slave device.

8. The method as claimed in claim 1, wherein the method of communicably connecting to the master device includes:
for each of the slave devices, when it is determined that the slave device is communicably connectable to the master device, by the slave device, communicably connecting to the master device and communicably connecting to at least one of the other slave devices which is not yet communicably connected to the slave device and which has relatively high signal strength of short-range wireless communication therewith.

9. The method as claimed in claim 1, wherein the step of transmitting the operation control signal to said specific one of the IoT devices includes:
when there are multiple signal transmission paths between the master device and said specific one of the IoT devices, by the master device, detecting transmission quality of each of the signal transmission paths, and selecting one of the signal transmission paths having the best transmission quality for transmission of the operation control signal.

10. The method as claimed in claim 1, each of the IoT devices having a service set identifier (SSID) and a password, the method further comprising:
receiving, by the master device, update information associated with the SSID and the password from a mobile device via one of the slave devices which is connected to the mobile device, the update information enabling the master device to update the SSID and pas sword thereof; and
transmitting, by the master device, the update information to each of the slave devices, the update information enabling each of the slave devices to update the SSID and password thereof.

11. An Internet of Things (IoT) system for controlling an electronic device, the IoT system comprising a plurality of IoT devices, each of the IoT devices being communicably connectable to at least one of the other IoT devices via short-range wireless communication, the electronic device being connected to and controlled by a specific one of the IoT devices;
wherein the IoT devices, through short-range wireless communication with each other, designate one of the IoT devices as a master device, and the IoT devices other than the master device as slave devices;
wherein each of the slave devices determines whether the slave device is communicably connectable to the master device;
wherein for each of the slave devices, when it is determined that the slave device is communicably connectable to the master device, the slave device communicably connects to the master device;
wherein for each of the slave devices, when it is determined that the slave device is not communicably connectable to the master device, and when there exists at least one of the other slave devices which is not yet communicably connected t o the slave device, the slave device communicably connects to at least one of the other slave devices which is not yet communicably connected to the slave device, so that at least one signal transmission path exists between the master device and the slave device;
wherein one of the IoT devices receives an operation control signal associated with the electronic device, and transmits the operation control signal to the master device via one of the at least one signal transmission path between the master device and said one of the IoT devices which receives the operation control signal; and
wherein, when said specific one of the IoT devices which is connected to the electronic device is one of the slave devices, the master device transmits the operation control signal to said specific one of the IoT devices via one of the at least one signal transmission path between the master device and said specific one of the IoT devices, the operation control signal enabling said specific one of the IoT devices to control the electronic device according to the operation control signal.

12. The IoT system as claimed in claim 11, wherein each of the slave devices determines whether the slave device is communicably connectable to the master device based on signal strength of short-range wireless communication between the slave device and the master device.

13. The IoT system as claimed in claim 11, wherein, for each of the slave devices, the slave device communicably connects to one of the other slave devices which is not yet communicably connected to the slave device and which has the highest signal strength of short-range wireless communication therewith.

14. The IoT system as claimed in claim 11, wherein one of the IoT devices which has the highest signal strength of short-range wireless communication with a mobile device receives the operation control signal from the mobile device via the short-range wireless communication therebetween when the mobile device determines that the mobile device is communicably connectable to at least one of the IoT devices via short-range wireless communication.

15. The IoT system as claimed in claim 14, wherein one of the IoT devices receives the operation control signal from the mobile device via the Internet when the mobile device determines that the mobile device is not communicably connectable to any of the IoT devices via short-range wireless communication.

16. The IoT system as claimed in claim 11, wherein each of the IoT devices has a respective serial number;
wherein the IoT devices determine, through short-range wireless communication with each other, that one of the IoT devices having the lowest serial number or one of the IoT devices having the highest serial number is to serve as the master device.

17. The IoT system as claimed in claim 11,
wherein, for each of the slave devices, when it is determined that the slave device is not communicably connectable to the master device, and when there exists at least one of the other slave devices which is not yet communicably connected t o the slave device, the slave device makes a determination as to whether there exists, among said at least one of the other slave devices which is not yet communicably connected to the slave device, at least one slave device which has an existing signal transmission path with the master device;
wherein, when a result of the determination made by the slave device is positive, the slave device communicably connects to, among said at least one slave device which has an existing signal transmission path existing with the master device, another slave device which has the highest signal strength of short-range wireless communication between the slave device; and
wherein, when the result of the determination made by the slave device is negative, the slave device communicably connects to one of the other slave devices which is not yet communicably connected to the slave device and which has the highest signal strength of short-range wireless communication with the slave device.

18. The IoT system as claimed in claim 11,
wherein, for each of the slave devices, when it is determined that the slave device is communicably connectable to the master device, the slave device communicably connects to the master device and further communicably connects to at least one of the other slave devices which is not yet communicably connected to the slave device and which has relatively high signal strength of short-range wireless communication with the slave device.

19. The IoT system as claimed in claim 11,
wherein, when there are multiple signal transmission paths between the master device and said specific one of the IoT devices, the master device detects transmission quality of each of the signal transmission paths, and selects one of the signal transmission paths having the best transmission quality for transmission of the operation control signal.

20. The IoT system as claimed in claim 11, each of the IoT devices having a service set identifier (SSID) and a password,
wherein the master device receives update information associated with the SSID and the password from a mobile device via one of the slave devices which is connected to the mobile device, the update information enabling the master device to update the SSID and password thereof; and
wherein the master device transmits the update information to each of the slave devices, the update information enabling each of the slave devices to update the SSID and password thereof.
